(19) United States
(12) Patent Application Publication
(10) Pub. No.: US 2006/0014049 A1
(43) Pub. Date: Jan. 19, 2006

(54) Ceramic green sheet, laminated ceramic article, and process for producing the same

(75) Inventors: Tsuyoshi Ichinose, Osaka (JP); Emiko Igaki, Hyogo (JP); Kazuhiro Komatsu, Hokkaido (JP); Masayuki Tanahashi, Osaka (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., LTD, OSAKA (JP)

(21) Appl. No.: 10/530,586

(22) PCT Filed: May 17, 2004
(86) PCT No.: PCT/JP04/06991

§ 371 Date: Apr. 7, 2005

(30) Foreign Application Priority Data
May 19, 2003 (JP) 2003-140840
Dec. 9, 2003 (JP) 2003-410793

(51) Int. Cl. B32B 15/04

(52) U.S. Cl. 428/701; 428/469; 428/702

(57) ABSTRACT

A ceramic green sheet is obtained by forming a ceramic coating containing at least a ceramic raw material powder, a binder, and an organic solvent in a sheet shape, followed by drying. The binder contains two or more kinds of polyvinyl acetal with different average degrees of polymerization, and polyvinyl acetal with a higher average degree of polymerization contains a relatively large amount of hydroxyl group, and polyvinyl acetal with a lower average degree of polymerization contains a relatively small amount of hydroxyl group. This green sheet is subjected to binder-removal and firing, thereby obtaining a ceramic capacitor in which inner electrode layers 2 and dielectric layers 1 are laminated alternately and external electrodes 3 are sintered at both ends of the laminate. Consequently, a decrease in the sheet strength caused by a reduction in the thickness of the dielectric layers is suppressed, and there are provided a high-strength green sheet, a laminated ceramic article, and a method for manufacturing the same.

### TECHNICAL FIELD

The present invention relates to a ceramic green sheet, a laminated ceramic article, and a method for manufacturing the same.

### BACKGROUND ART

Conventionally, laminated ceramic articles such as a laminated ceramic capacitor as shown in FIG. 1 are manufactured by a method as described in the following patent document 1. Initially, various kinds of ceramic powders as raw materials are mixed, followed by calcining and grinding, whereby a ceramic powder having a desired composition and particle diameter is obtained. Then, the obtained ceramic powder is mixed with an organic binder, an organic solvent, and the like at a predetermined ratio, so that a ceramic coating is prepared. The ceramic coating is formed in a sheet shape with a predetermined thickness by a doctor blade method or the like, thereby producing a ceramic green sheet that serves as a dielectric layer after firing. After that, a conductive coating for forming an inner electrode is pattern-printed on the ceramic green sheet, resulting in the ceramic green sheet on which an inner electrode coating film that serves as an inner electrode layer after firing is formed. Alternatively, the conductive coating for forming an inner electrode is pattern-printed on a carrier such as a polyethylene terephthalate (PET) film in advance, and the obtained inner electrode coating film is transferred onto the ceramic green sheet, resulting in the ceramic green sheet on which the inner electrode coating film is formed. The thus-obtained ceramic green sheet on which the inner electrode coating film is formed is laminated one after another such that the inner electrode layer and the dielectric layer are arranged alternately, followed by compression bonding and cutting, whereby green chips are produced.

As another method for producing green chips, it is also possible that the conductive coating for forming an inner electrode is pattern-printed on a carrier such as a PET film in advance and the green sheet and the obtained inner electrode coating film are laminated alternately such that the inner electrode layer and the dielectric layer are arranged alternately, followed by compression bonding. Finally, the obtained green chips are subjected to binder-removal and firing, and external electrodes are formed as appropriate, whereby a laminated ceramic article is produced. In this manner, a ceramic capacitor is obtained in which inner electrode layers 2 and dielectric layers 1 are laminated alternately and external electrodes 3 are formed at both ends of the laminate.

With a recent trend toward compact lightweight electronic equipment, compact high-performance electronic components are being developed rapidly. Among them, for a laminated ceramic article, in particular a laminated ceramic capacitor, there is a need to make dielectric layers and inner electrode layers thinner and to laminate a large number of these layers, so as to achieve a compact high-capacity capacitor. In particular, the dielectric layers have become remarkably thinner, and in recent years a dielectric layer with a thickness of even 3 μm or less has been available on the market. In order to make the dielectric layers thinner, it is necessary to make ceramic green sheets before firing thinner. However, if the ceramic green sheets become further thinner, the strength of the sheets is reduced, and the ceramic green sheets are stretched by a pressure applied when being laminated. As a result, laminate displacement of the inner electrode layers or the like may occur. As a solution to this, the following patent document 2 describes a method in which a binder included in a ceramic green sheet is formed of two kinds of binders with different average degrees of polymerization. Further, the following patent document 3 describes a method in which two kinds of binders containing different amounts of hydroxyl group are used.

Patent document 1: JP 8(1996)-316089 A (FIG. 4)

Patent document 2: JP 3(1991)-170360A

Patent document 3: JP 10(1998)-67567 A

However, in the conventional methods, in order to increase the strength of the sheets, it is required to increase the average degree of polymerization of a binder or to mix a binder with a higher degree of polymerization in a larger amount. This however leads to a significant rise in viscosity of a ceramic coating, and accordingly the formability of the ceramic green sheets is deteriorated.

### DISCLOSURE OF INVENTION

The present inventors have found that when an average degree of polymerization of a binder is increased, a binder with a higher degree of polymerization is mixed in a larger amount, or a content of hydroxyl group in a binder is increased, although the strength of a ceramic green sheet is increased, the adhesion between the ceramic sheets is deteriorated, resulting in delamination or the like.

According to the present invention, the strength of a ceramic green sheet is increased without raising the viscosity of a ceramic coating significantly, and a deterioration in the adhesion between the ceramic green sheets is suppressed. Consequently, there are provided a ceramic green sheet that can be laminated with high accuracy, a laminated ceramic article, and a method for manufacturing the same.

A ceramic green sheet according to the present invention is obtained by forming a ceramic slurry containing at least a ceramic raw material powder, a binder, and an organic solvent in a sheet shape, followed by drying. The binder contains two or more kinds of polyvinyl acetal with different average degrees of polymerization, and polyvinyl acetal with a higher average degree of polymerization contains a relatively large amount of hydroxyl group, and polyvinyl acetal with a lower average degree of polymerization contains a relatively small amount of hydroxyl group.

A laminated ceramic article according to the present invention is obtained by producing a ceramic coating containing at least a ceramic raw material powder, a binder, and an organic solvent, forming the obtained ceramic coating in a sheet shape, followed by drying, whereby a ceramic green sheet is produced, and producing a laminate using the ceramic green sheet and an inner electrode sheet or producing a laminate using the ceramic green sheet on which an inner electrode is formed, followed by binder-removal and firing. The ceramic green sheet is the ceramic green sheet according to the present invention.

A method for manufacturing a laminated ceramic article according to the present invention includes at least: producing a ceramic coating containing at least a ceramic raw material powder, a binder, and an organic solvent; forming the obtained ceramic coating in a sheet shape, followed by drying, whereby a ceramic green sheet is produced; producing a laminate using the ceramic green sheet and an inner electrode sheet or producing a laminate using the ceramic green sheet on which an inner electrode is formed; and subjecting the laminate to binder-removal and firing. The ceramic green sheet is the ceramic green sheet according to the present invention.

### BRIEF DESCRIPTION OF DRAWINGS

FIG. 1 is a cross-sectional view of a laminated ceramic capacitor according to a conventional example and one example of the present invention.

### BEST MODE FOR CARRYING OUT THE INVENTION

According to the present invention, a ceramic green sheet obtained by forming a ceramic slurry containing at least a ceramic raw material powder, a binder, and an organic solvent in a sheet shape, followed by drying includes the binder that contains at least two kinds of polyvinyl acetal with different average degrees of polymerization, each of which is a random polymer represented by the following Formula 1 (where 0<X<100; 0<Y<100; 0<Z<100; X+Y+Z=100 mol %; and R is an alkyl group having a carbon number of 1 to 6).

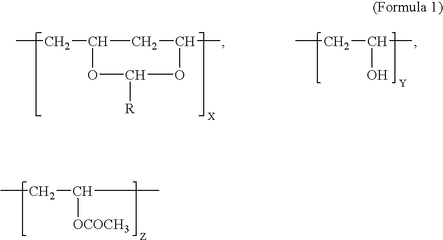

The polyvinyl acetal resin contains an acetal group, a hydroxyl group, and an acetyl group as functional groups. The acetal group is represented by the following Formula 2. 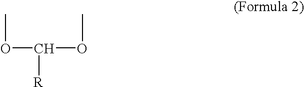
(where R is CₙH₂ₙ₊₁; and n is an integer of 1 to 6)

The binder contains two or more kinds of polyvinyl acetal with different average degrees of polymerization, and polyvinyl acetal with a higher average degree of polymerization contains a relatively large amount of hydroxyl group, and polyvinyl acetal with a lower average degree of polymerization contains a relatively small amount of hydroxyl group. As a result, there is provided a high-strength ceramic green sheet without deteriorating the adhesion. Further, a high-quality laminated ceramic article is produced by using the obtained ceramic green sheet.

It is preferable that a difference in average degree of polymerization between at least two kinds of the binder is not less than about 300, and that the amount of the hydroxyl group in the binder with a lower average degree of polymerization is less than about 25 mol % of a total amount of functional groups contained in the binder with a lower degree of polymerization and the amount of the hydroxyl group in the binder with a higher average degree of polymerization is not less than about 25 mol % of a total amount of functional groups contained in the binder with a higher degree of polymerization.

With respect to a mixed amount of each binder, when at least an amount of the binder with a lower degree of polymerization is not less than 10 wt % of a total amount of the binder, and an amount of the binder with a higher degree of polymerization is not less than 10 wt % of the total amount of the binder, the present invention can achieve a higher effect. An upper limit for the mixed amounts is not particularly limited, and a mix ratio that allows a desired optimum viscosity to be obtained may be selected. When the amount of the binder with a higher degree of polymerization is less than 10 wt % of the total amount of the binder, the sheet strength is not increased significantly. When the amount of the binder with a lower degree of polymerization is less than 10 wt % of the total amount of the binder, the adhesion between the ceramic green sheets tends to be deteriorated.

With respect to the average degree of polymerization of each binder, when a difference in average degree of polymerization between the binder with a lower degree of polymerization and the binder with a higher degree of polymerization is about 300, a desired effect can be obtained. A higher effect can be produced when the average degree of polymerization of the binder with a lower degree of polymerization is not more than about 600, and the average degree of polymerization of the binder with a higher degree of polymerization is not less than about 900. Particularly preferably, the average degree of polymerization of the binder with a lower degree of polymerization is not more than about 500, and the average degree of polymerization of the binder with a higher degree of polymerization is not less than about 1000.

The glass transition temperature of each polyvinyl acetal is not particularly limited as long as the polyvinyl acetal with a higher average degree of polymerization has a relatively high glass transition temperature and the polyvinyl acetal with a lower average degree of polymerization has a relatively low glass transition temperature.

A desired effect can be obtained more remarkably when a difference in glass transition temperature between the polyvinyl acetal with a higher average degree of polymerization and the polyvinyl acetal with a lower average degree of polymerization is not less than 5° C., and more preferably not less than 10° C.

The polyvinyl acetal resin represented by the Formula 1 for use as binders contains the acetal group represented by the Formula 2, an acetyl group, and a hydroxyl group as functional groups. However, amounts of the acetal group and the acetyl group as well as a kind of R of the acetal group are not particularly limited. In general, the amount of the acetyl group is not more than about 20 mol % of a total amount of the functional groups, and the amount of the acetal group is not less than about 50 mol % of the total amount of the functional groups. Further, with respect to a kind of R of the acetal group, one obtained when n=1, 3, or the like is used generally. In consideration of the flexibility for allowing easy handling of the green sheet, R of the acetal group in the binder with a lower degree of polymerization is more preferably one obtained when n=3 (i.e., C₃H₇). The amount of the acetyl group in the binder with a lower degree of polymerization is desirably not less than about 3 mol %. An effect can be obtained when R of the acetal group in the binder with a higher degree of polymerization is one obtained when n=1 or 3 (i.e., CH₃ or C₃H₇), and more preferably n=1. The amount of the acetyl group in the binder with a high degree of polymerization is desirably not less than about 3 mol %.

The ceramic green sheet has a porosity of 10 to 60 vol %, and more preferably 15 to 50 vol %. When the porosity is less than 10 vol %, the thickness of the inner electrode cannot be accommodated, and accordingly the adhesion between the ceramic green sheets becomes insufficient, resulting in a tendency for delamination or the like to occur. On the other hand, when the porosity is more than 60 vol %, the strength of the green sheet itself tends to decrease.

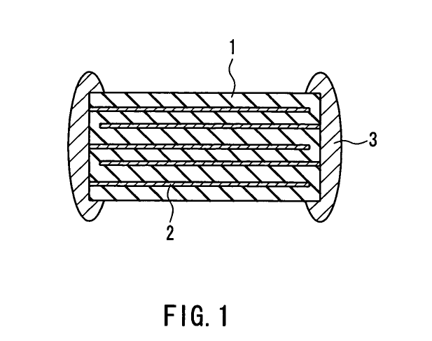

By using this green sheet, it is possible to produce a high-quality laminated ceramic article with little laminate displacement of inner electrode layers. This green sheet is subjected to binder-removal and firing, thereby obtaining a ceramic capacitor as shown in FIG. 1, for example, in which inner electrode layers 2 and dielectric layers 1 are laminated alternately and external electrodes 3 are sintered at both ends of the laminate. Consequently, a decrease in the sheet strength caused by a reduction in the thickness of the dielectric layers is suppressed, and there are provided a high-strength green sheet, a laminated ceramic article, and a method for manufacturing the same.

According to the present invention, the strength of the ceramic green sheet is increased without significantly raising the viscosity of a ceramic coating, and a deterioration in the adhesion between the ceramic green sheets is suppressed, whereby the ceramic green sheet that is capable of being laminated with high accuracy can be provided. Further, by using this green sheet, it is possible to produce a high-quality laminated ceramic article such as, for example, a laminated ceramic capacitor.

Next, specific examples of the present invention will be described.

### EXAMPLE 1

First, 100 g of barium titanate-based ceramic powder as a common dielectric material for a laminated ceramic capacitor, 70 g of mixed solvent of toluene, ethanol, and dibutyl phthalate, and as binders, 5 g of polyvinyl acetal resin that has an average degree of polymerization of about 300, a hydroxyl group content of about 21 mol %, a glass transition temperature of about 62° C., and an acetyl group content of about 3 mol %, and contains an acetal group represented by the Formula (2) where R is one obtained when n=3, as well as 5 g of polyvinyl acetal resin that has an average degree of polymerization of about 1500, a hydroxyl group content of about 34 mol %, a glass transition temperature of about 89° C., and an acetyl group content of about 3 mol %, and contains an acetal group represented by the Formula (2) where R is one obtained when n=1 were stirred to be mixed using a ball mill, whereby a ceramic coating was produced. The produced ceramic coating was formed in a sheet shape by a doctor blade method, resulting in a green sheet having a thickness of 20 μm. By using the obtained green sheet, a surface peeling strength and a tensile strength were measured. The surface peeling strength was evaluated with respect to an area with a diameter of 15 mm by using two ceramic green sheets that were laminated at 250 kg/cm² in advance. With respect to the tensile strength, a tensile test was performed using a strip specimen having a sheet width of 10 mm at a chuck-to-chuck distance of 30 mm and a pulling speed of 10 mm/min, and a strength obtained when a stretched length is 5 mm was evaluated. The results are shown in Table 1 below.

### EXAMPLE 2

A measurement was carried out in the same manner as in Example 1 except that as binders, 5 g of polyvinyl acetal resin that has an average degree of polymerization of about 300, a hydroxyl group content of about 21 mol %, a glass transition temperature of about 62° C., and an acetyl group content of about 3 mol %, and contains an acetal group represented by the Formula (2) where R is one obtained when n=3, and 5 g of polyvinyl acetal resin that has an average degree of polymerization of about 1500, a hydroxyl group content of about 33 mol %, a glass transition temperature of about 73° C., and an acetyl group content of about 3 mol %, and contains an acetal group represented by the Formula (2) where R is one obtained when n=3 were used. The results are shown in Table 1 below.

### EXAMPLE 3

A measurement was carried out in the same manner as in Example 1 except that as binders, 4 g of polyvinyl acetal resin that has an average degree of polymerization of about 300, a hydroxyl group content of about 21 mol %, a glass transition temperature of about 62° C., and an acetyl group content of about 3 mol %, and contains an acetal group represented by the Formula (2) where R is one obtained when n=3, 4 g of polyvinyl acetal resin that has an average degree of polymerization of about 1500, a hydroxyl group content of about 34 mol %, a glass transition temperature of about 89° C., and an acetyl group content of about 3 mol %, and contains an acetal group represented by the Formula (2) where R is one obtained when n=1, and 2 g of polyvinyl acetal resin that has an average degree of polymerization of about 800, a hydroxyl group content of about 22 mol %, a glass transition temperature of about 61° C., and an acetyl group content of about 3 mol %, and contains an acetal group represented by the Formula (2) where R is one obtained when n=3 were used. The results are shown in Table 1 below.

### EXAMPLE 4

A measurement was carried out in the same manner as in Example 1 except that as binders, 4 g of polyvinyl acetal resin that has an average degree of polymerization of about 300, a hydroxyl group content of about 21 mol %, a glass transition temperature of about 62° C., and an acetyl group content of about 3 mol %, and contains an acetal group represented by the Formula (2) where R is one obtained when n=3, 4 g of polyvinyl acetal resin that has an average degree of polymerization of about 1500, a hydroxyl group content of about 34 mol %, a glass transition temperature of about 89° C., and an acetyl group content of about 3 mol %, and contains an acetal group represented by the Formula (2) where R is one obtained when n=1, and 2 g of polyvinyl acetal resin that has an average degree of polymerization of about 800, a hydroxyl group content of about 29 mol %, a glass transition temperature of about 64° C., and an acetyl group content of about 3 mol %, and contains an acetal group represented by the Formula (2) where R is one obtained when n=3 were used. The results are shown in Table 1 below.

### EXAMPLE 5

A measurement was carried out in the same manner as in Example 1 except that as binders, 5 g of polyvinyl acetal resin that has an average degree of polymerization of about 300, a hydroxyl group content of about 21 mol %, a glass transition temperature of about 59° C., and an acetyl group content of about 10 mol %, and contains an acetal group represented by the Formula (2) where R is one obtained when n=3, and 5 g of polyvinyl acetal resin that has an average degree of polymerization of about 1500, a hydroxyl group content of about 34 mol %, a glass transition temperature of about 84° C., and an acetyl group content of about 10 mol %, and contains an acetal group represented by the Formula (2) where R is one obtained when n=1 were used. The results are shown in Table 1 below.

### EXAMPLE 6

A measurement was carried out in the same manner as in Example 1 except that as binders, 5 g of polyvinyl acetal resin that has an average degree of polymerization of about 300, a hydroxyl group content of about 21 mol %, a glass transition temperature of about 59° C., and an acetyl group content of about 10 mol %, and contains an acetal group represented by the Formula (2) where R is one obtained when n=3, and 5 g of polyvinyl acetal resin that has an average degree of polymerization of about 1500, a hydroxyl group content of about 33 mol %, a glass transition temperature of about 69° C., and an acetyl group content of about 10 mol %, and contains an acetal group represented by the Formula (2) where R is one obtained when n=3 were used. The results are shown in Table 1 below.

### COMPARATIVE EXAMPLE 1

A measurement was carried out in the same manner as in Example 1 except that as binders, 5 g of polyvinyl acetal resin that has an average degree of polymerization of about 300, a hydroxyl group content of about 21 mol %, a glass transition temperature of about 62° C., and an acetyl group content of about 3 mol %, and contains an acetal group represented by the Formula (2) where R is one obtained when n=3, and 5 g of polyvinyl acetal resin that has an average degree of polymerization of about 300, a hydroxyl group content of about 34 mol %, a glass transition temperature of about 75° C., and an acetyl group content of about 3 mol %, and contains an acetal group represented by the Formula (2) where R is one obtained when n=1 were used. The results are shown in Table 1 below.

### COMPARATIVE EXAMPLE 2

A measurement was carried out in the same manner as in Example 1 except that as binders, 5 g of polyvinyl acetal resin that has an average degree of polymerization of about 1500, a hydroxyl group content of about 22 mol %, a glass transition temperature of about 67° C., and an acetyl group content of about 3 mol %, and contains an acetal group represented by the Formula (2) where R is one obtained when n=3, and 5 g of polyvinyl acetal resin that has an average degree of polymerization of about 1500, a hydroxyl group content of about 34 mol %, a glass transition temperature of about 89° C., and an acetyl group content of about 3 mol %, and contains an acetal group represented by the Formula (2) where R is one obtained when n=1 were used. The results are shown in Table 1 below.

### COMPARATIVE EXAMPLE 3

A measurement was carried out in the same manner as in Example 1 except that as binders, 5 g of polyvinyl acetal resin that has an average degree of polymerization of about 300, a hydroxyl group content of about 21 mol %, a glass transition temperature of about 62° C., and an acetyl group content of about 3 mol %, and contains an acetal group represented by the Formula (2) where R is one obtained when n=3, and 5 g of polyvinyl acetal resin that has an average degree of polymerization of about 1500, a hydroxyl group content of about 24 mol %, a glass transition temperature of about 93° C., and an acetyl group content of about 3 mol %, and contains an acetal group represented by the Formula (2) where R is one obtained when n=1 were used. The results are shown in Table 1 below.

### COMPARATIVE EXAMPLE 4

A measurement was carried out in the same manner as in Example 1 except that as binders, 5 g of polyvinyl acetal resin that has an average degree of polymerization of about 300, a hydroxyl group content of about 35 mol %, a glass transition temperature of about 68° C., and an acetyl group content of about 3 mol %, and contains an acetal group represented by the Formula (2) where R is one obtained when n=3, and 5 g of polyvinyl acetal resin that has an average degree of polymerization of about 1500, a hydroxyl group content of about 34 mol %, a glass transition temperature of about 89° C., and an acetyl group content of about 3 mol %, and contains an acetal group represented by the Formula (2) where R is one obtained when n=1 were used. The results are shown in Table 1 below.

### COMPARATIVE EXAMPLE 5

A measurement was carried out in the same manner as in Example 1 except that as binders, 5 g of polyvinyl acetal resin that has an average degree of polymerization of about 300, a hydroxyl group content of about 28 mol %, a glass transition temperature of about 60° C., and an acetyl group content of about 3 mol %, and contains an acetal group represented by the Formula (2) where R is one obtained when n=3, and 5 g of polyvinyl acetal resin that has an average degree of polymerization of about 1500, a hydroxyl group content of about 22 mol %, a glass transition temperature of about 67° C., and an acetyl group content of about 3 mol %, and contains an acetal group represented by the Formula (2) where R is one obtained when n=3 were used. The results are shown in Table 1 below.

### COMPARATIVE EXAMPLE 6

A measurement was carried out in the same manner as in Example 1 except that as binders, 5 g of polyvinyl acetal resin that has an average degree of polymerization of about 300, a hydroxyl group content of about 21 mol %, a glass transition temperature of about 62° C., and an acetyl group content of about 3 mol %, and contains an acetal group represented by the Formula (2) where R is one obtained when n=3, and 5 g of polyvinyl acetal resin that has an average degree of polymerization of about 1500, a hydroxyl group content of about 30 mol %, a glass transition temperature of about 66° C., and an acetyl group content of about 3 mol %, and contains an acetal group represented by the Formula (2) where R is one obtained when n=3 were used. The results are shown in Table 1 below.

TABLE 1

| | Sheet | Surface |
|---|---|---|
| | strength | peeling |
| | (N/mm²) | strength (N) |
| Example 1 | 7.0 | 33.2 |
| Example 2 | 6.4 | 33.5 |
| Example 3 | 6.1 | 31.1 |
| Example 4 | 6.2 | 30.5 |
| Example 5 | 6.8 | 34.2 |
| Example 6 | 6.2 | 34.4 |
| Comparative Example 1 | 3.3 | 34.9 |
| Comparative Example 2 | 7.5 | 5.3 |
| Comparative Example 3 | 5.4 | 16.1 |
| Comparative Example 4 | 5.6 | 15.6 |
| Comparative Example 5 | 5.0 | 14.2 |
| Comparative Example 6 | 5.6 | 33.8 |

As is apparent from the results above, it was confirmed that from the aspects of both the sheet strength and the surface peeling strength, more favorable characteristics were obtained in Examples 1 to 6 than in Comparative Examples 1 to 6.

The results of Example 1 and Comparative Examples 1 and 2 show that a difference in average degree of polymerization between the binder with a lower degree of polymerization and the binder with a higher degree of polymerization is preferably not less than 300.

Comparisons between Example 1 and Comparative Examples 3 to 5 show that the amount of a hydroxyl group in the binder with a lower degree of polymerization is favorably less than about 25 mol % and the amount of a hydroxyl group in the binder with a higher degree of polymerization is favorably not less than about 25 mol %.

The results of Examples 1 to 4 show that even in the case where three kinds of binders are included, when a difference in average degree of polymerization between at least two kinds of the binders is not less than about 300, and the amount of a hydroxyl group in the binder with a lower degree of polymerization is less than about 25 mol % and the amount of a hydroxyl group in the binder with a higher degree of polymerization is not less than about 25 mol %, no limitation on the remaining binder is needed.

A comparison between Example 2 and Comparative Example 6 shows that a difference in glass transition temperature between the binder with a higher average degree of polymerization and the binder with a lower average degree of polymerization is more preferably not less than 5° C.

The results of Examples 1, 2, 5, and 6 show that a larger amount of acetyl group provides better adhesion.

The present examples have been described by taking as an example the green sheet for a laminated ceramic capacitor as an example of a laminated ceramic article. However, the present invention is not limited to the green sheet for a laminated ceramic capacitor, and the same effects as in the present examples can be obtained when the present invention is applied to green sheets for other laminated ceramic articles such as, for example, a laminated ceramic substrate and a laminated actuator.

### INDUSTRIAL APPLICABILITY

The green sheet according to the present invention can be applied to laminated ceramic articles such as a laminated ceramic capacitor, laminated ceramic substrate, and a laminated actuator.

1. A ceramic green sheet obtained by forming a ceramic coating containing at least a ceramic raw material powder, a binder, and an organic solvent in a sheet shape, followed by drying,
wherein the binder contains two or more kinds of polyvinyl acetal with different average degrees of polymerization, and
polyvinyl acetal with a higher average degree of polymerization contains a relatively large amount of hydroxyl group, and polyvinyl acetal with a lower average degree of polymerization contains a relatively small amount of hydroxyl group.

2. The ceramic green sheet according to claim 1, wherein a difference in average degree of polymerization between the two or more kinds of polyvinyl acetal with different average degrees of polymerization is not less than 300.

3. The ceramic green sheet according to claim 1, wherein the amount of the hydroxyl group in the polyvinyl acetal with a lower average degree of polymerization is less than 25 mol % of a total amount of functional groups contained in the polyvinyl acetal with a lower degree of polymerization.

4. The ceramic green sheet according to claim 1, wherein the amount of the hydroxyl group in the polyvinyl acetal with a higher average degree of polymerization is not less than 25 mol % of a total amount of functional groups contained in the polyvinyl acetal with a higher degree of polymerization.

5. The ceramic green sheet according to claim 1, wherein the polyvinyl acetal with a lower average degree of polymerization has an average degree of polymerization of not more than 600.

6. The ceramic green sheet according to claim 1, wherein the polyvinyl acetal with a higher average degree of polymerization has an average degree of polymerization of not less than 900.

7. The ceramic green sheet according to claim 1, wherein an amount of the polyvinyl acetal with a lower average degree of polymerization is in a range of 10 to 90 wt % of a total amount of the binder included in the ceramic green sheet, and an amount of the polyvinyl acetal with a higher average degree of polymerization is in a range of 90 to 10 wt % of the total amount of the binder included in the ceramic green sheet.

8. The ceramic green sheet according to claim 1, wherein of the two or more kinds of polyvinyl acetal with different average degrees of polymerization, the polyvinyl acetal with a higher average degree of polymerization has a relatively high glass transition temperature, and the polyvinyl acetal with a lower average degree of polymerization has a relatively low glass transition temperature.

9. The ceramic green sheet according to claim 1, wherein a difference in glass transition temperature between the polyvinyl acetal with a higher average degree of polymerization and the polyvinyl acetal with a lower average degree of polymerization of the two or more kinds of polyvinyl acetal with different average degrees of polymerization is not less than 50° C.

10. The ceramic green sheet according to claim 1, wherein each of the two or more kinds of polyvinyl acetal is a random polymer represented by the following Formula 1 (where 0<X<100; 0<Y<100; 0<Z<100; X+Y+Z=100 mol %; and R is an alkyl group having a carbon number of 1 to 6).

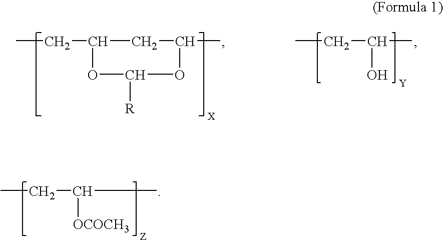

11. The ceramic green sheet according to claim 10, wherein in the Formula 1, R of an acetal group in the polyvinyl acetal with a lower degree of polymerization is C₃H₇.

12. The ceramic green sheet according to claim 10, wherein in the Formula 1, R of an acetal group in the polyvinyl acetal with a higher degree of polymerization is CH₃ or C₃H₇.

13. The ceramic green sheet according to claim 1, wherein a content of acetyl group in the polyvinyl acetal with a lower degree of polymerization is not less than 3 mol % of a total amount of functional groups contained in the polyvinyl acetal with a lower degree of polymerization.

14. The ceramic green sheet according to claim 1, wherein a content of acetyl group in the polyvinyl acetal with a higher degree of polymerization is not less than 3 mol % of a total amount of functional groups contained in the polyvinyl acetal with a higher degree of polymerization.

15. The ceramic green sheet according to claim 1, having a porosity of 10 to 60 vol %.

16. A laminated ceramic article obtained by producing a ceramic coating containing at least a ceramic raw material powder, a binder, and an organic solvent, forming the obtained ceramic coating in a sheet shape, followed by drying, whereby a ceramic green sheet is produced, and producing a laminate using the ceramic green sheet and an inner electrode sheet or producing a laminate using the ceramic green sheet on which an inner electrode is formed, followed by binder-removal and firing,
wherein the ceramic green sheet is obtained by forming a ceramic coating containing at least a ceramic raw material powder, a binder, and an organic solvent in a sheet shape, followed by drying,
the binder contains two or more kinds of polyvinyl acetal with different average degrees of polymerization, and
polyvinyl acetal with a higher average degree of polymerization contains a relatively large amount of hydroxyl group, and polyvinyl acetal with a lower average degree of polymerization contains a relatively small amount of hydroxyl group.

17. The laminated ceramic article according to claim 16, wherein the laminated ceramic article is a laminated ceramic capacitor.

18. A method for manufacturing a laminated ceramic article comprising at least: producing a ceramic coating containing at least a ceramic raw material powder, a binder, and an organic solvent; forming the obtained ceramic coating in a sheet shape, followed by drying, whereby a ceramic green sheet is produced; producing a laminate using the ceramic green sheet and an inner electrode sheet or producing a laminate using the ceramic green sheet on which an inner electrode is formed; and subjecting the laminate to binder-removal and firing,
wherein the ceramic green sheet is obtained by forming a ceramic coating containing at least a ceramic raw material powder, a binder, and an organic solvent in a sheet shape, followed by drying,
the binder contains two or more kinds of polyvinyl acetal with different average degrees of polymerization, and
polyvinyl acetal with a higher average degree of polymerization contains a relatively large amount of hydroxyl group, and polyvinyl acetal with a lower average degree of polymerization contains a relatively small amount of hydroxyl group.
